(19) United States
(12) Patent Application Publication
(10) Pub. No.: US 2025/0355010 A1
(43) Pub. Date: Nov. 20, 2025

(54) MICROSCOPY SLIDE TRANSFER BETWEEN SAMPLE PREPARATION AND IMAGING DEVICES

(71) Applicant: SCOPIO LABS LTD., Tel Aviv (IL)

(72) Inventors: Oren HAREL, Hatzor (IL); Eran SMALL, Yahood (IL); Noa BEN ZVI, Givataim (IL); Erez NA’AMAN, Tel Aviv (IL)

(73) Assignee: SCOPIO LABS LTD., Tel Aviv (IL)

(21) Appl. No.: 18/876,407

(22) PCT Filed: Jul. 19, 2023
(86) PCT No.: PCT/IL2023/050757

§ 371 Date: Dec. 18, 2024

Related U.S. Application Data
(60) Provisional application No. 63/369,278, filed on Jul. 25, 2022.

(51) Int. Cl. G01N 35/00; G02B 21/34; G02B 21/36

(52) U.S. Cl. CPC G01N 35/0099; G01N 35/00029; G01N 35/00732; G02B 21/34; G02B 21/362; G01N 2035/00039; G01N 2035/00138; G01N 2035/00752; G01N 2035/00772; G01N 2035/00782; G01N 2035/00831

(57) ABSTRACT

A slide transfer device is configured to transfer a plurality of slides from a first container to a second container, which can improve compatibility between slide preparation devices and microscopes. The first container is configured to receive slides from a slide preparation device, and the second container is configured to provide slides to a slide loader of a microscope. The first container may not be compatible with the microscope slide loader. The first container may differ from the second container by one or more of a maximum distance across, a slide capacity, a number of slide receptacles, a distance between slide receptacles, or a size of slide receptacles. The plurality of slides comprises a first orientation and a first order in the first container and the slide transfer device is configured to provide the plurality of slides to the second container with a second orientation or a second order.

### RELATED APPLICATIONS

This application claims the benefit under 35 U.S.C. § 119(e) of U.S. Provisional Patent Application No. 63/369,278, filed Jul. 25, 2022, which is incorporated, in its entirety, by this reference.

### BACKGROUND

Microscopy plays an important role in the analysis of samples such as blood samples. The analysis of samples such as blood samples can play an important role in the screening, diagnosis and prognosis of patients, and delays in returning results can be problematic such that a patient may not receive an appropriate treatment in a timely manner.

Prior approaches to preparing and analyzing samples can be somewhat time consuming and more complex than would be ideal. Although efforts have been made to automate at least some aspects of the sample preparation and microscopy process, the prior approaches can be somewhat less than ideal in at least some respects. For example, there can be compatibility issues between slide preparation systems and microscopy systems, which can lead to less than ideal automation. Some prior slide preparation systems will automatically prepare and stain samples, such as with a slide maker/staining device, and load the slides into a container such as a cassette or magazine, and some microscopy systems will automatically load slides from a container into a microscope. However, the slide container used with the sample preparation system may not be compatible with the slide container used with the microscopy system, which can result in decreased automation and manual tasks being performed to move the slides from the slide preparation cassette to the cassette used with the microscope. Also, the slides in the cassette from the slide preparation system may not be in an appropriate order for use with the microscopy system. Although some prior approaches have suggested using the same container for the slide preparation system and the microscopy system, this approach can be somewhat less than ideal because it limits compatibility among different systems and could lead to increased complexity in the design or execution of an integration between the systems, which could increase costs, time, engineering effort or managerial effort and may affect the motivation or ability to engage in such a project and reduce the chances of a successful project. Additionally, there is a somewhat greater risk that materials such as dyes can be transferred from the container to the microscope in at least some instances or oils or glues that can be transferred to the slide preparation system or microscope.

Furthermore, in some cases the speed of transfer of slides between the containers may be faster than the speed of sample acquisition by the microscope. Hence, in some cases, prior methods such as transferring the slides one by one or in certain container types can lead to increased time spent on loading or slide transferring, which can reduce the throughput of the system.

In light of the above, there is a need for improved methods and apparatuses that ameliorate at least some of the aforementioned limitations of the prior approaches.

### SUMMARY

In some embodiments, a slide transfer device is configured to transfer a plurality of slides from a first container to a second container, which can improve compatibility between slide preparation devices and microscopes. In some embodiments, the first container is configured to receive slides from a slide preparation device, such as a slide stainer, and the second container is configured to provide slides to a slide loader of a microscope. In some embodiments, the first container is not compatible with the microscope slide loader. In some embodiments, the first container differs from the second container by one or more of a maximum distance across, a slide capacity, a number of slide receptacles, a distance between slide receptacles, or a size of slide receptacles. In some embodiments the plurality of slides comprises one or more of a first orientation or a first order in the first container and the slide transfer device is configured to provide the plurality of slides to the second container with one or more of a second orientation or a second order, which can improve the work flow and automation of the preparation and imaging of the plurality of slides.

In a first aspect, an apparatus comprises a microscope configured to generate magnified digital images of samples, a first container configured to hold a plurality of slides, a second container configured to receive the plurality of slides from the first container, wherein the second container differs from the first container, a slide loader configured to load the plurality of slides from the second container to the microscope, and a transfer device comprising a support configured to transfer the plurality of slides from the first container to the second container. In some embodiments, the slide loader for the microscope and slide transfer device may differ in that the slide transfer device is compatible with the first container and the second container, while the slide loader for the microscope is compatible with the second container and the microscope.

In another aspect, a method of transferring slides comprises transferring a plurality of slides from a first container to a second container with a support configured to move the plurality of slides from the first container to the second container.

### INCORPORATION BY REFERENCE

All patents, applications, and publications referred to and identified herein are hereby incorporated by reference in their entirety, and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1 shows a diagram of an exemplary microscope, in accordance with some embodiments;

FIGS. 2A and 2B show a system for the processing of slides with a slide preparation device, a slide transfer device, and a microscope, in accordance with some embodiments;

FIG. 3 shows a slide transfer device to transfer slides between a first container and a second container, in accordance with some embodiments;

FIGS. 4A to 4C show the transfer of slides from a first container to a second container with a slide transfer device, in accordance with some embodiments;

FIGS. 5A and 5B show access to slides in a first container and a second container and the transfer of slides from the first container to the second container, in accordance with some embodiments;

FIGS. 6A to 6C a guide configured to allow the plurality of slides to slide between the first container and the second container, in accordance with some embodiments; and

FIG. 7 shows a method of transferring slides from a first container to a second container, in accordance with some embodiments.

### DETAILED DESCRIPTION

The following detailed description provides a better understanding of the features and advantages of the inventions described in the present disclosure in accordance with the embodiments disclosed herein. Although the detailed description includes many specific embodiments, these are provided by way of example only and should not be construed as limiting the scope of the inventions disclosed herein.

The presently disclosed systems, methods and apparatuses are well suited for combination with prior approaches to analyzing samples such as blood samples and blood smears. For example, the optical scanning apparatus may comprise one or more components of a conventional microscope with a sufficient numerical aperture, or a computational microscope as described in U.S. patent application Ser. No. 15/775,389, filed on Nov. 10, 2016, entitled “Computational microscopes and methods for generating an image under different illumination conditions,” published as US20190235224. The system may comprise one or more components of an autofocus system, for example as described in U.S. Pat. No. 10,705,326, entitled “Autofocus system for a computational microscope”. While the system may comprise any suitable user interface and data storage, in some embodiments, the system comprises one or more components for data storage and user interaction as described in U.S. Pat. No. 10,935,779, entitled “Digital microscope which operates as a server”. The system may comprise one or more components of an autoloader for loading slides, for example as described in U.S. patent application Ser. No. 16/875,665, filed on May 15, 2020, entitled “Multi/parallel scanner”. The system may comprise one or more components for selectively scanning areas of a sample, for example as described in U.S. patent application Ser. No. 16/875,721, filed on May 15, 2020, entitled “Accelerating digital microscopy scans using empty/dirty area detection,” published as US20200278530. The system may comprise a grid with a known pattern to facilitate image reconstruction, for example as described in U.S. Pat. No. 10,558,029, entitled “System for image reconstruction using a known pattern”. The system may comprise one or more classifiers as described in US 17/755,356, entitled, “Method and apparatus for visualization of bone marrow cell populations”, published as US20220415480 on Dec. 29, 2022, which can be modified by one of ordinary skill in the art in accordance with the present disclosure. Each of the aforementioned patents and applications is incorporated herein by reference.

The presently disclosed system and method is well suited for use with automated methods of analyzing cellular morphology and classifiers, for example as described in PCT/IL2021/051329, filed on Nov. 9, 2021, entitled “FULL FIELD MORPHOLOGY—PRECISE QUANTIFICATION OF CELLULAR AND SUB-CELLULAR MORPHOLOGICAL EVENTS IN RED/WHITE BLOOD CELLS”, published as WO/2022/097155 on Dec. 1, 2022.

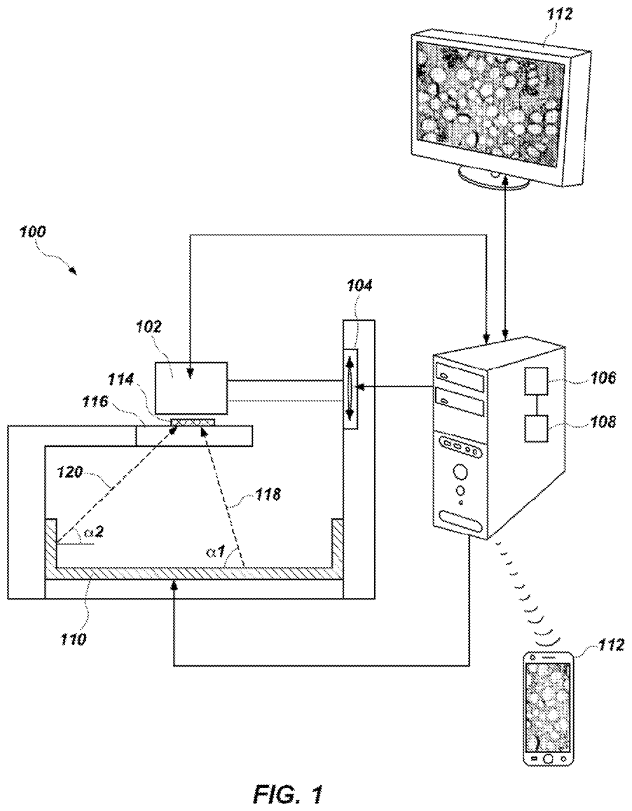

FIG. 1 is a diagrammatic representation of a microscope 100 consistent with the exemplary disclosed embodiments. The term “microscope” as used herein generally refers to any device or instrument for magnifying an object which is smaller than easily observable by the naked eye, e.g., capable of creating an image of an object for a user where the image is larger than the object. One type of microscope may be an “optical microscope” that uses light in combination with an optical system for magnifying an object. An optical microscope may be a simple microscope having one or more magnifying lens, or an optical microscope in which images are constructed from holograms with a digital holographic microscope, for example. Another type of microscope may be a “computational microscope” that comprises an image sensor and image-processing algorithms to enhance or magnify the object's size or other properties. The computational microscope may be a dedicated device or created by incorporating software and/or hardware with an existing optical microscope to produce high-resolution digital images. As shown in FIG. 1, microscope 100 comprises an image capture device 102, a focus actuator 104, a controller 106 connected to memory 108, an illumination assembly 110, and a user interface 112. An example usage of microscope 100 may be capturing images of a sample 114 mounted on a stage 116 located within the field-of-view (FOV) of image capture device 102, processing the captured images, and presenting on user interface 112 a magnified image of sample 114. Although reference is made to the presentation magnified images on a user interface, in some embodiments the processor is configured to automatically acquire the image data without displaying the magnified image of the sample 114 on the user interface, for example. Alternatively or in combination, the magnified image can be viewed by a user for morphological review of the sample, for example when the sample has been flagged for morphological review by a specialist such as a pathologist as described herein.

Image capture device 102 may be used to capture images of sample 114. In this specification, the term “image capture device” as used herein generally refers to a device that records the optical signals entering a lens as an image or a sequence of images. The optical signals may be in the near-infrared, infrared, visible, and ultraviolet spectrums. Examples of an image capture device comprise a CCD camera, a CMOS camera, a color camera, a photo sensor array, a video camera, a mobile phone equipped with a camera, a webcam, a preview camera, a microscope objective and detector, etc. Some embodiments may comprise only a single image capture device 102, while other embodiments may comprise two, three, or even four or more image capture devices 102. In some embodiments, image capture device 102 may be configured to capture images in a defined field-of-view (FOV). Also, when microscope 100 comprises several image capture devices 102, image capture devices 102 may have overlap areas in their respective FOVs. Image capture device 102 may have one or more image sensors (not shown in FIG. 1) for capturing image data of sample 114. In other embodiments, image capture device 102 may be configured to capture images at an image resolution higher than VGA, higher than 1 Megapixel, higher than 2 Megapixels, higher than 5 Megapixels, 10 Megapixels, higher than 12 Megapixels, higher than 15 Megapixels, or higher than 20 Megapixels. In addition, image capture device 102 may also be configured to have a pixel size smaller than 15 micrometers, smaller than 10 micrometers, smaller than 5 micrometers, smaller than 3 micrometers, or smaller than 1.6 micrometer.

In some embodiments, microscope 100 comprises focus actuator 104. The term “focus actuator” as used herein generally refers to any device capable of converting input signals into physical motion for adjusting the relative distance between sample 114 and image capture device 102. Various focus actuators may be used, including, for example, linear motors, electrostrictive actuators, electrostatic motors, capacitive motors, voice coil actuators, magnetostrictive actuators, etc. In some embodiments, focus actuator 104 may comprise an analog position feedback sensor and/or a digital position feedback element. Focus actuator 104 is configured to receive instructions from controller 106 in order to make light beams converge to form a clear and sharply defined image of sample 114. In the example illustrated in FIG. 1, focus actuator 104 may be configured to adjust the distance by moving image capture device 102.

However, in other embodiments, focus actuator 104 may be configured to adjust the distance by moving stage 116, or by moving both image capture device 102 and stage 116. Microscope 100 may also comprise controller 106 for controlling the operation of microscope 100 according to the disclosed embodiments. Controller 106 may comprise various types of devices for performing logic operations on one or more inputs of image data and other data according to stored or accessible software instructions providing desired functionality. For example, controller 106 may comprise a central processing unit (CPU), support circuits, digital signal processors, integrated circuits, cache memory, or any other types of devices for image processing and analysis such as graphic processing units (GPUs). The CPU may comprise any number of microcontrollers or microprocessors configured to process the imagery from the image sensors. For example, the CPU may comprise any type of single-or multi-core processor, mobile device microcontroller, etc. Various processors may be used, including, for example, processors available from manufacturers such as Intel®, AMD®, etc. and may comprise various architectures (e.g., x86 processor, ARM®, etc.). The support circuits may be any number of circuits generally well known in the art, including cache, power supply, clock and input-output circuits. Controller 106 may be at a remote location, such as a computing device communicatively coupled to microscope 100.

In some embodiments, controller 106 may be associated with memory 108 used for storing software that, when executed by controller 106, controls the operation of microscope 100. In addition, memory 108 may also store electronic data associated with operation of microscope 100 such as, for example, captured or generated images of sample 114. In one instance, memory 108 may be integrated into the controller 106. In another instance, memory 108 may be separated from the controller 106.

Specifically, memory 108 may refer to multiple structures or computer-readable storage mediums located at controller 106 or at a remote location, such as a cloud server. Memory 108 may comprise any number of random-access memories, read only memories, flash memories, disk drives, optical storage, tape storage, removable storage and other types of storage.

Microscope 100 may comprise illumination assembly 110. The term “illumination assembly” as used herein generally refers to any device or system capable of projecting light to illuminate sample 114.

Illumination assembly 110 may comprise any number of light sources, such as light emitting diodes (LEDs), LED array, lasers, and lamps configured to emit light, such as a halogen lamp, an incandescent lamp, or a sodium lamp. For example, illumination assembly 110 may comprise a Kohler illumination source. Illumination assembly 110 may be configured to emit polychromatic light. For instance, the polychromatic light may comprise white light.

In some embodiments, illumination assembly 110 may comprise only a single light source. Alternatively, illumination assembly 110 may comprise four, sixteen, or even more than a hundred light sources organized in an array or a matrix. In some embodiments, illumination assembly 110 may use one or more light sources located at a surface parallel to illuminate sample 114. In other embodiments, illumination assembly 110 may use one or more light sources located at a surface perpendicular or at an angle to sample 114.

In addition, illumination assembly 110 may be configured to illuminate sample 114 in a series of different illumination conditions. In one example, illumination assembly 110 may comprise a plurality of light sources arranged in different illumination angles, such as a two-dimensional arrangement of light sources. In this case, the different illumination conditions may comprise different illumination angles. For example, FIG. 1 depicts a beam 118 projected from a first illumination angle α1, and a beam 120 projected from a second illumination angle α2. In some embodiments, first illumination angle α1 and second illumination angle α2 may have the same value but opposite sign. In other embodiments, first illumination angle α1 may be separated from second illumination angle α2. However, both angles originate from points within the acceptance angle of the optics. In another example, illumination assembly 110 may comprise a plurality of light sources configured to emit light in different wavelengths. In this case, the different illumination conditions may comprise different wavelengths. For instance, each light source may be configured to emit light with a full width half maximum bandwidth of no more than 50 nm so as to emit substantially monochromatic light. In yet another example, illumination assembly 110 may be configured to use a number of light sources at predetermined times. In this case, the different illumination conditions may comprise different illumination patterns. For example, the light sources may be arranged to sequentially illuminate the sample at different angles to provide one or more of digital refocusing, aberration correction, or resolution enhancement. Accordingly and consistent with the present disclosure, the different illumination conditions may be selected from a group including different durations, different intensities, different positions, different illumination angles, different illumination patterns, different wavelengths, or any combination thereof.

Although reference is made to computational microscopy, the presently disclosed systems and methods are well suited for use with many types of microscopy and microscopes such as one or more of a high definition microscope, a digital microscope, a scanning digital microscope, a 3D microscope, a phase imaging microscope, a phase contrast microscope, a dark field microscope, a differential interference contrast microscope, a light-sheet microscope, a confocal microscope, a holographic microscope, a computational microscope, or a fluorescence-based microscope.

In some embodiments, image capture device 102 may have an effective numerical aperture (“NA”) of at least 0.8, although any effective NA may be used. In some embodiments, the effective NA corresponds to a resolving power of the microscope that has the same resolving power as an objective lens with that NA under relevant illumination conditions. Image capture device 102 may also have an objective lens with a suitable NA to provide the effective NA, although the NA of the objective lens may be less than the effective NA of the microscope. For example, the imaging apparatus may comprise a computational microscope to reconstruct an image from a plurality of images captured with different illumination angles as described herein, in which the reconstructed image corresponds to an effective NA that is higher than the NA of the objective lens of the image capture device. In some embodiments with conventional microscopes, the NA of the microscope objective corresponds to the effective NA of the images. The lens may comprise any suitable lens such as an oil immersion lens or a non-oil immersion lens.

Consistent with disclosed embodiments, microscope 100 may comprise, be connected with, or in communication with (e.g., over a network or wirelessly, e.g., via Bluetooth) user interface 112. The term “user interface” as used herein generally refers to any device suitable for presenting data such as numerical results, microscope image data, or a magnified image of sample 114, or any device suitable for receiving inputs from one or more users of data related to microscope 100, such as remote users, for example. FIG. 1 illustrates two examples of user interface 112. The first example is a smartphone or a tablet wirelessly communicating with controller 106 over a Bluetooth, cellular connection or a Wi-Fi connection, directly or through a remote server. The second example is a PC display physically connected to controller 106. In some embodiments, user interface 112 may comprise user output devices, including, for example, a display, tactile device, speaker, etc. In other embodiments, user interface 112 may comprise user input devices, including, for example, a touchscreen, microphone, keyboard, pointer devices, cameras, knobs, buttons, etc. With such input devices, a user may be able to provide information inputs or commands to microscope 100 by typing instructions or information, providing voice commands, selecting menu options on a screen using buttons, pointers, or eye-tracking capabilities, or through any other suitable techniques for communicating information to microscope 100. User interface 112 may be connected (physically or wirelessly) with one or more processing devices, such as controller 106, to provide and receive information to or from a user and process that information. In some embodiments, such processing devices may execute instructions for responding to keyboard entries or menu selections, recognizing and interpreting touches and/or gestures made on a touchscreen, recognizing and tracking eye movements, receiving and interpreting voice commands, etc.

Microscope 100 may also comprise or be connected to stage 116. Stage 116 comprises any horizontal rigid surface where sample 114 may be mounted for examination. Stage 116 may comprise a mechanical connector for retaining a slide containing sample 114 in a fixed position. The mechanical connector may use one or more of the following: a mount, an attaching member, a holding arm, a clamp, a clip, an adjustable frame, a locking mechanism, a spring or any combination thereof. In some embodiments, stage 116 may comprise a translucent portion or an opening for allowing light to illuminate sample 114. For example, light transmitted from illumination assembly 110 may pass through sample 114 and towards image capture device 102. In some embodiments, stage 116 and/or sample 114 may be moved using motors or manual controls in the XY plane to enable imaging of multiple areas of the sample.

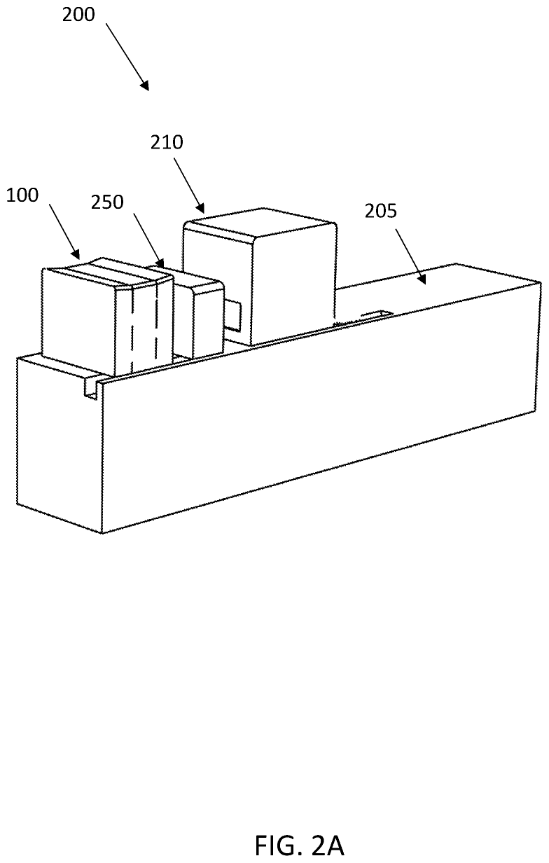

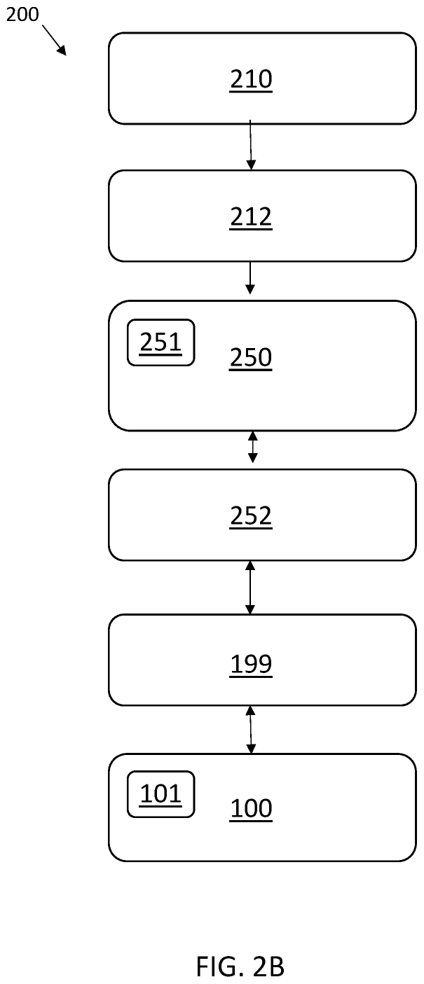

FIGS. 2A and 2B show a system 200 for the processing of slides with a slide preparation device 210, a slide transfer device 250, and a microscope 100 as described herein. The slide preparation device, the slide transfer device and the microscope may comprise modular components that can be arranged in any suitable way and may be placed on a bench 205, for example. In some embodiments, another device is located upstream in the workflow, such as a complete blood count (“CBC”) machine, for example.

The slide preparation device 210 may comprise any suitable slide preparation device such as a slide maker stainer, for example, as will be understood by one of ordinary skill in the art. In some embodiments the slide preparation device is configured to provide a plurality of smeared slides. In some embodiments, the slide preparation device comprises an automated slide stainer.

In some embodiments, the slide preparation device 210 is configured to place a plurality of slides in a container 212, which may allow the slides to be generated and processed in sequentially or batches, for example. Once a slide has been prepared with the slide preparation device 210, the prepared slide is place in container 212, which may comprise a first container, for example. The container 212 may comprise any suitable slide holder and may comprise a cassette or a magazine configured to hold a plurality of slides, for example. The container 212 may comprise a plurality of receptacles to receive and hold the plurality of slides from the slide preparation device.

The slide transfer device 250 is configured to receive a plurality of slides from the container 212 and transfer the plurality of slides to the container 252. In some embodiments the container 212 for the slide preparation device is different from container 252 for the microscope. In some embodiments, the slide loader of the microscope is not configured to work with the first container. For example, a slide loader of the microscope may not be compatible with the first container. In some embodiments, the first container differs from the second container by one or more of a maximum distance across, a slide capacity, a number of slide receptacles, a distance between slide receptacles, or a size of slide receptacles. In some embodiments, the slide loader is not capable of loading slides from the first container when the first container has been placed at a location corresponding to a location of the second container to load slides into the microscope.

In some embodiments, the slide transfer device comprises a container transfer device configured to move the second container from a slide transfer location to a slide loader location. The container transfer device may comprise any suitable device, such as a linkage, a conveyor, a conveyor belt, or a chain, for example.

In some embodiments, the slide transfer device is configured to remove slides from the first container 212 and place the removed slides in the second container 252 to transfer the slides between the two different containers, which can facilitate and automate the workflow in some embodiments.

In some embodiments, the slide transfer device 250 comprises a reader 251 configured to read an identification code on each of the plurality of slides. In some embodiments, the reader 251 is configured to read an identification code of the container 212. The identification code of the slides or the container may comprise any suitable identification code, such as one or more of an optical code, a bar code, a quick response (QR) code, or a radio frequency identification (RFID), and the reader 251 may comprise one more of a optical code reader, a bar code reader, a QR code reader or an RFID reader.

In some embodiments, the slide transfer device is configured to position the plurality of slides to orient the readable code in the second container within a range of a reader.

The container 252 can be configured in any suitable way. The container 252 may comprise any suitable slide holder and may comprise a cassette or a magazine configured to hold a plurality of slides, for example. In some embodiments, the container 252 is configured to receive the plurality of slides received from slide transfer device 250 provide the plurality of slides to a slide loader 199 of the microscope 100.

In some embodiments, microscope 100 comprises a slide loader configured 199 to load one or more slides into microscope 100. The slide loader can be coupled to the microscope in many ways, and may comprise a component of the microscope or a separate device that is external to the microscope and loads the microscope. The slide loader may comprise any suitable slide loader as will be known by one of ordinary skill in the art. In some embodiments, the microscope 100 comprises a reader 101 configured to read identification codes from one or more of the container 252 or the plurality of slides. In some embodiments, the reader 199 is configured to read an identification code of the container 222. The identification code of the slides and the identification code of the container may comprise any suitable identification code as described herein, and the reader 101 may comprise any suitable reader as described herein, such as one or more one more of an optical code reader, a bar code reader, a QR code reader or an RFID reader.

While the slide transfer device can be configured in many ways, in some embodiments the slide transfer device is configured to sequentially transfer the plurality of slides from the first container to the second container. Alternatively, the slide transfer device can be configured to transfer the plurality of slides together, for example in batches. In some embodiments, the slide transfer device is configured to transfer a plurality of slides simultaneously from the first container to the second container.

In some embodiments, the slide transfer device is configured to maintain an order of the plurality of slides between the first container and the second container. In some embodiments, the plurality of microscope slides is arranged in a sequential order at a first plurality of locations on the first container and the slide transfer device is configured to transfer the plurality of slides to the second container and maintain the sequential order at a second plurality of locations on the second container. In some embodiments, the first plurality of locations on the first container corresponds to one or more empty slots between two or more slides on the first container and the second plurality of locations corresponds to no empty slots between the two or more slides on the second container.

In some embodiments, the slide transfer device is configured to change an order of the slides transferred from the first container to the second container. For example, the slide transfer device can be configured to change the order to prioritize one or more slides of the plurality of slides.

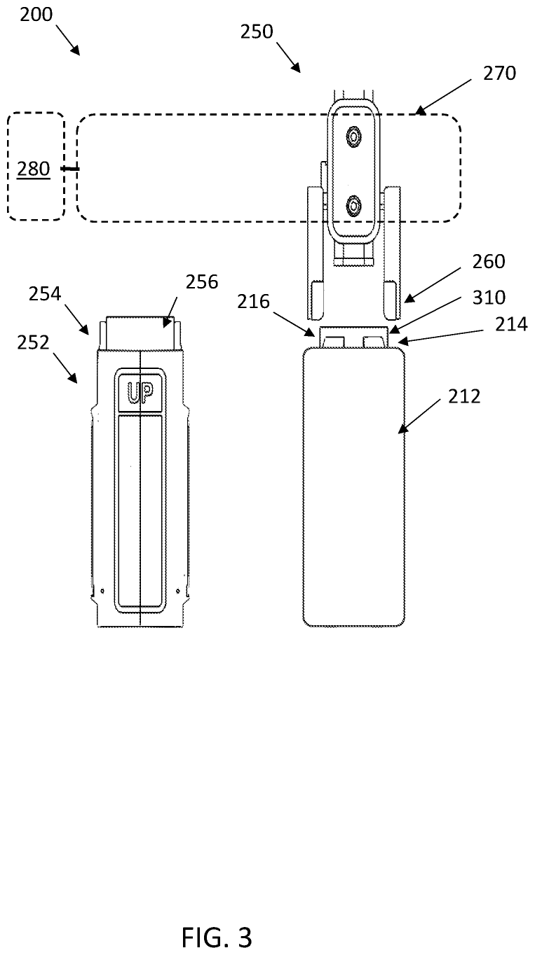

FIG. 3 shows a slide transfer device 250 to transfer slides between first container 212 and second container 252. In some embodiments, slide transfer device 250 comprises a support 260 configured to support one or more slides 310 to transfer the plurality of slides from the first container 212 to the second container 252. In some embodiments a linkage 270 is coupled to the support 260 to move the plurality of slides from the first container to the second container. In some embodiments, the first container 212 comprises a plurality of receptacles 214 configured to hold a plurality of slides, and the second container 252 comprises a plurality of receptacles 254 configured to receive a plurality of slides from the slide transfer device 250. The plurality of receptacles 214 can be configured in any suitable way and may comprise a plurality of slots, for example. The plurality of receptacles 254 can be configured in any suitable way and may comprise a plurality of slots, for example.

In some embodiments, a processor 280 is operatively coupled to the linkage 270 to transfer the slides from the first container to the second container in response to instructions from the processor.

The support 260 can be configured in many ways and may comprise one or more of an extension, a finger, fingers, a fork, a grip, an adhesive element, a vacuum holder, a guide, a surface to support the slide, a sliding surface, a pushing mechanism, a pulling mechanism, a magnetic holder, an end effector, or a rotating stage, for example.

The linkage 270 can be configured in many ways. In some embodiments, the linkage is configured to move the support, with a slide supported thereon, between a first receptacle of the first container to a second receptacle of the second container. In some embodiments, the linkage comprises one or more motors coupled to one or more gears to move the support, and optionally two or more motors coupled to two or more gears and further optionally three or more motors coupled to three or more gears, for example. In some embodiments, the linkage comprises one or more of a robotic arm, a 6 or more degree of freedom robotic arm, a translation stage, a two dimensional translation stage, or a three dimensional translation stage, a rotating stage, a gantry, a delta robot, or a pulley, for example.

The processor 280 can be configured in many ways and may comprise any suitable processor as described herein. In some embodiments, the processor is configured with instructions to maintain a sequential order of slides from a first sequential order on the first container to a second sequential order on the second container. In some embodiments, the processor 280 is configured with instructions to change a sequential order of slides from a first sequential order on the first container to a second sequential order on the second container.

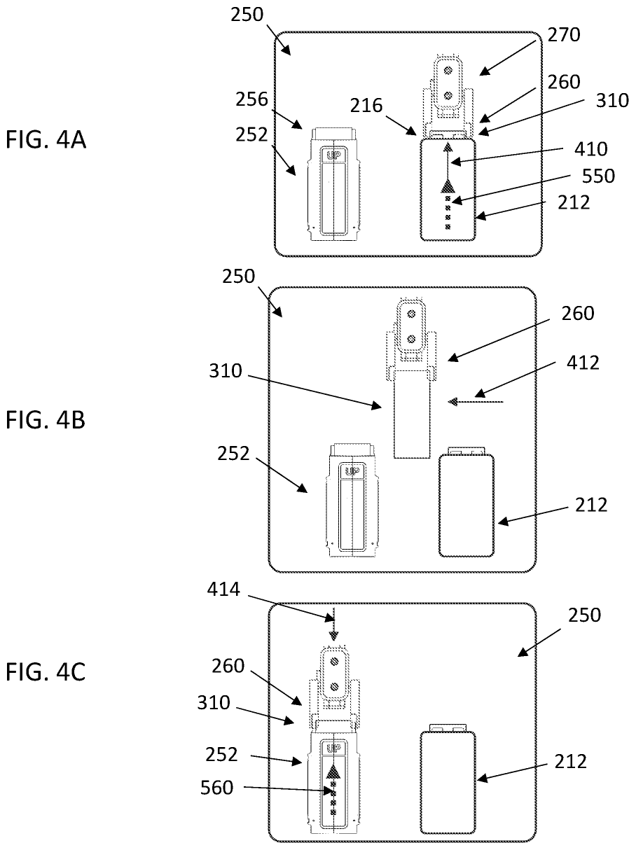

FIGS. 4A to 4C show the transfer of slides from a first container to a second container with a slide transfer device. In some embodiments, the support 260 is moved with linkage 270 to a position of engagement with one or more slides 310. The support 260 is translated with linkage 270 to remove the one or more slides from container 212 as shown with arrow 410 in FIG. 4A. The support 260 is translated with linkage 270 to move the one or more slides 310 toward the second container 252 as shown with arrow 412 of FIG. 4B. The support 260 is translated with linkage 270 to move the one or more slides 310 into the second container 252 as shown with arrow 414 of FIG. 4B. Although reference is made to translational movements as shown with arrows 410, 412, 414, respectively, the movements may comprise any suitable movement such as one or more of a translational movement or a rotational movement, for example. In some embodiments, the one or more slides 310 comprises a first orientation 550 in the first container 212 and a second orientation 560 in the second container 252.

In some embodiments, the first container 212 comprises a first opening 216 to access the one or more slides 310 on a first side of the container 212, and the second container 252 comprises a second opening 256 to access the one or more slides 310 on a second side of the container 212. In some embodiments, the orientation of the one or more slides 310 is maintained with respect to the first opening 216 of the first container and the second opening 256 of the second container. Alternatively or in combination, the one or more slides 310 can be rotated with the linkage to provide a different orientation of the one or more slides between the first container 212 and the second container 252.

In some embodiments, the plurality of slides comprises a first orientation in the first container and a second orientation in the second container. In some embodiments, the first orientation is substantially similar to the second orientation. In some embodiments, the slide transfer device is configured to maintain an orientation of the plurality of slides between the first container and the second container. In some embodiments, the slide transfer device is configured to change an orientation of the plurality of slides from a first orientation in the first container to a second orientation in the second container.

The first orientation of the plurality of slides in the first container and the second orientation of the plurality of slides in the second container may comprise any suitable orientation. In some embodiments, the orientation is such that the loader is configured to remove the plurality of slides from the second container and place the plurality of slides in one or more of the microscope or the slide loader in a way that is compatible with image acquisition of the microscope. In some embodiments, the first orientation comprises a substantially vertical orientation and the second orientation comprises a substantially vertical orientation and wherein the first orientation differs from the second orientation by a rotation of the slide about an axis of rotation extending through the slide. In some embodiments, the first orientation comprises a substantially horizontal orientation and the second orientation comprises a substantially horizontal orientation and wherein the first orientation differs from the second orientation by a rotation of the slide about an axis of rotation extending through the slide. In some embodiments, the first orientation comprises a substantially horizontal orientation and the second orientation comprises a substantially vertical orientation. In some embodiments, the first orientation comprises a substantially vertical orientation and the second orientation comprises a substantially horizontal orientation.

While the first orientation 550 and the second orientation 560 can be referenced in many ways, in some embodiments the first orientation corresponds to a plane extending along a length and a width of each of the plurality of slides, and the second orientation corresponds to the plane extending along the length and the width of each of the plurality of slides. In some embodiments, each of the plurality of slides comprises a thickness transverse to the length and the width of the slide, for example.

In some embodiments, the first orientation and the second orientation are referenced with respect to a fixed reference frame, such as the earth. Alternatively or in combination, the first orientation and the second orientation can be referenced with respect to a first access opening of the first container and a second access opening of the second container as described herein.

The linkage can be configured to provide any suitable orientation of the plurality of slides as described herein.

In some embodiments, the slide transfer device 250 is configured to transfer the plurality of slides to a third container, for example subsequent to imaging the plurality of slides.

In some embodiments the first container 212 and the second container 252 remain at substantially fixed locations during the transfer of the plurality of slides from the first container to the second container. In some embodiments, one or more of the first container or the second container moves during the slide transfer, for example to align the containers to facilitate transfer of the slides. Alternatively or in combination, the slide transfer device may comprise a container transferring device to transfer the second container from a first location for slide transfer to a second location to interact with the slide loader of the microscope. In some embodiments, container transfer device is located between the slide transfer device and the slide loader. In some embodiments, the container transferring device is located between a location of the slide transfer device and a location of the slide loader.

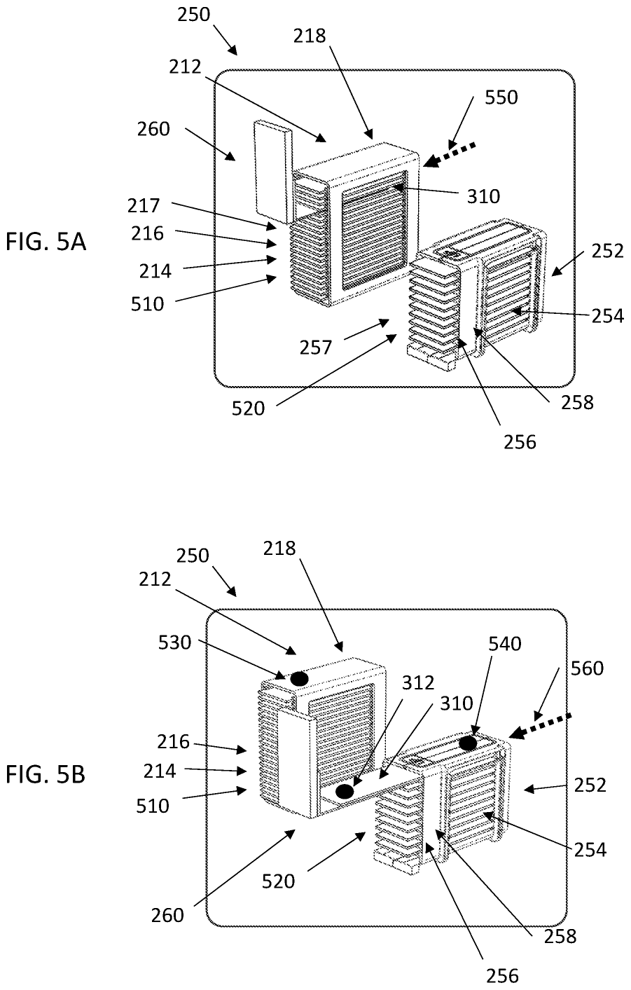

FIGS. 5A and 5B show access to slides in a first container 212 and a second container 252 and the transfer of slides from the first container to the second container. In some embodiments, the first container 212 comprises a plurality of receptacles 214 which can be accessed through one or more openings 216 of the first container 212, and the first container 252 comprises a plurality of receptacles 254 which can be accessed through one or more openings 256 of the second container 252. In some embodiments, the one or more openings 216 are sized to receive a portion of the support 260, and support 260 engages the one or more slides 310 as described herein. In some embodiments, the one or more openings 256 are sized to receive a portion of the support 260, and support 260 releases the one or more slides 310 in one or more of the plurality of receptacles 254. In some embodiments, each of the one or more slides 310 in the first container 212 comprises a first orientation 550, and each of the one or more slides 310 comprises a second orientation 560 when placed in the second container 252.

In some embodiments, one or more of the first container 212, the second container 252, or the one or more slides 310 comprises a readable identifier. In some embodiments, the one or more slides comprises a readable identifier 312, and each of the plurality of slides may comprise the readable identifier 312. In some embodiments, the first container 212 comprises a first readable identifier 330. In some embodiments the second container 252 comprises a readable identifier 340. In some embodiments, the readable identifier 312 of the one or more slides 310 is arranged with respect to a reader as described herein. In some embodiments, the readable identifier 312 of each of the plurality of slides is oriented with respect to one or more of the readable identifier 330 of the first container 212 or the readable identifier 340 of the second container 252.

The plurality of slides can be transferred from the first container to the second container in any suitable way. In some embodiments, the one or more slides are transferred sequentially between the first container and the second container. Alternatively or in combination, the plurality of slides can be transferred in parallel, e.g. simultaneously, between the first container and the second container.

In some embodiments the first container 212 comprises a first accessible side 217 for accessing the plurality of slides through the one or more openings 216 on the first container and the second container 252 comprises a second accessible side 257 for accessing the plurality of slides 310 through the second one or more openings 256 on the second container 252. In some embodiments, the first accessible side 217 comprises one or more openings 216 to access the plurality of slides on a plurality of receptacles 214 of the first container 212. In some embodiments, the second accessible side 257 comprises one or more openings 256 to access the plurality of slides on a plurality of receptacles 254 of the second container 252.

In some embodiments, the second container may receive slides from a plurality of first containers. Alternatively or in combination, in some embodiments a first container may contain slides that are loaded by the slide transfer into a plurality of second containers.

In some embodiments, the first accessible side 217 and the second accessible side 257 comprise a substantially similar orientation, such as facing a similar direction.

In some embodiments, the first accessible side 217 and the second accessible side 257 comprise a substantially different orientation. For example, the first opening on the first side of the first container can be orientated towards the opening on the side of the first container. In some embodiments, the first one or more access openings of the first container faces the one or more access openings of the second container.

In some embodiments, the first accessible side 217 comprises a substantially vertical orientation and the second accessible side 257 comprises a substantially vertical orientation with the one or more slides 310 orientated horizontally, for example as shown with reference to FIGS. 5A and 5B.

In some embodiments, a first plurality of slides 510 stored in the first container 212 are arranged in a first order, and a second plurality of slides stored in the second container 252 are arranged in a second order 520. The slide transfer device can be configured to maintain or change the order in any suitable way as described herein.

In some embodiments, the first accessible side comprises a substantially horizontal orientation and the second accessible side comprises a substantially vertical orientation.

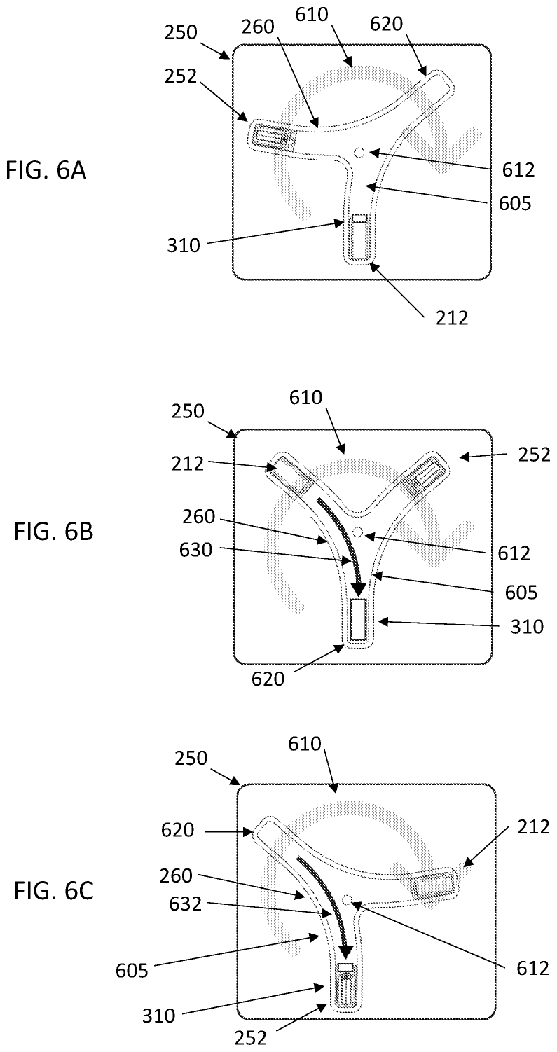

FIGS. 6A to 6C show the support 260 comprising a guide 605 configured to allow the plurality of slides to slide between the first container and the second container. The guide may comprise a single guide to transfer slides sequentially, or a plurality of guides configured to transfer the plurality of slides simultaneously, for example in a parallel configuration. The guide 605 transfers the slides from a first container 212 to a second container 252 with a sliding support 260, which is configured to allow the one or more slides 310 to slide along guide 605 to a desired location. In some embodiments, the one or more slides 310 can slide along support 260 between the first container 212 and the second container 252 in response to gravity. In some embodiments, a motor may be used to create additional motion such as vibration to help facilitate the motion of the slide, which may decrease the chances of a slides getting stuck along the way. While the support 260 can be configured to in many ways, in some embodiments, sliding support 260 is configured to rotate about an axis 612 as shown with arrow 610.

In some embodiments, support 260 comprises a receptacle 620 for maintaining an orientation of the one or more slides 310 with respect to an opening to the first container 212 and an opening to the second container 252. With a first orientation, the one or more slides 310 is located in the first container 212 as shown in FIG. 6A. With a second orientation, the first container 212 is rotated to release the one or more slides 310 and provide the one or more slides to receptacle 620, for example with sliding of the one or more slides 310 along guide 605 as shown in FIG. 6B. With a third orientation the one or more slides 310 slides along guide 605 to the second container 252.

In some embodiments, the linkage comprises a gear configured to rotate the support 260 about axis 612, and the linkage operatively coupled to a processor as described herein.

In some embodiments, the orientation of the one or more slides 310 is substantially similar with respect to access opening 256 of the second container 252 as compared with the orientation of the one or more slides 310 with respect to the access opening 216 of the first container 212. In some embodiments, this is provided with receptacle 620. Alternatively or in combination, the linkage 270 can be configured to maintain the orientation, for example as described herein.

Although FIGS. 6A to 6C make reference for a receptacle 620 to maintain an orientation of the one or more slide 310 in the first container 212 and the second container 252, in some embodiments, the guide 605 is configured to transfer the one or more slides 310 directly from the first container to the second container, for example without receptacle 620. In some embodiments, the orientation of the one or more slides 310 is reversed with respect to access opening 256 of the second container 252 as compared with the orientation of the one or more slides 310 with respect to the access opening 216 of the first container 212.

Although reference is made herein to microscope 100, in some embodiments microscope 100 comprises a plurality of microscopes. In some embodiments, the system 200 comprises a plurality of microscopes. Alternatively or in combination, the slide transfer device can be configured to transfer slides to a plurality of microscopes.

In some embodiments, the second container is loaded manually into the microscope after the transfer. In some embodiments, the second container may also be placed manually such that the container transfer device will move it to the slide loader.

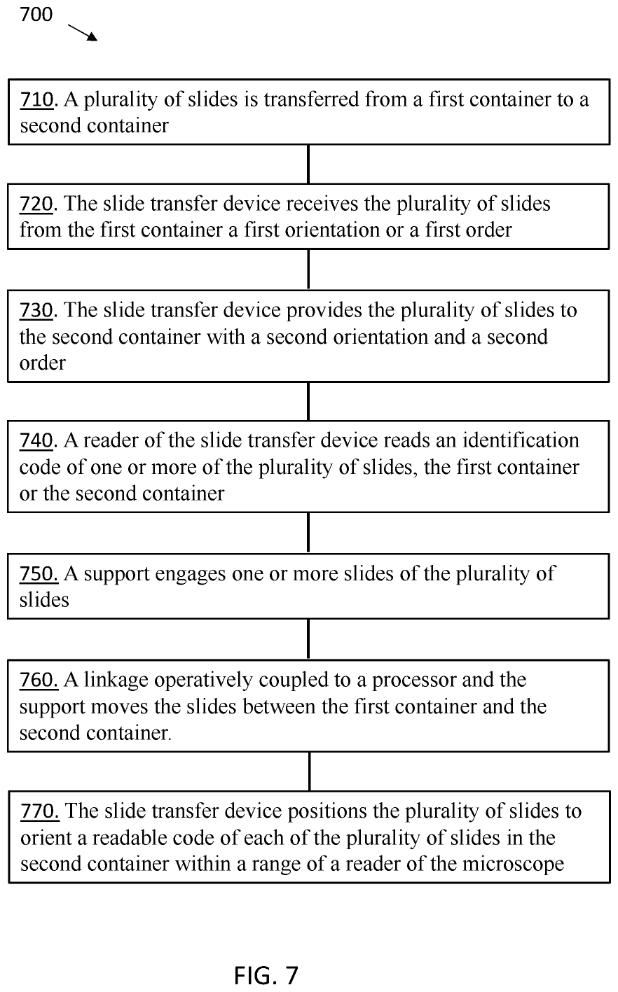

FIG. 7 shows a method 700 of transferring slides from a first container to a second container.

At a step 710 a plurality of slides is transferred from a first container to a second container. In some embodiments, a support moves the plurality of slides from the first container to the second container. In some embodiments, the first container differs from the second container, for example as described herein.

At a step 720 the slide transfer device receives the plurality of slides from the first container in a first orientation or a first order, for example as described herein.

At a step 730, the slide transfer device provides the plurality of slides to the second container with a second orientation and a second order.

At a step 740 a reader reads an identification code of one or more of the plurality of slides, the first container or the second container. The reader may comprise any suitable reader as described herein, and the reader may comprise a reader of one or more of the slide transfer device, the slide loader of the microscope, or the microscope, for example. In some embodiments, the slide transfer device is configured to transfer the plurality of slides in the response to the identification code. In some embodiments, the slide transfer device is configured to maintain one or more of an order or an orientation of the plurality of slides between the first container and the second container. In some embodiments, the slide transfer device is configured to change one or more of an order or an orientation of the plurality of slides between the first container and the second container.

At a step 750, a support engages one or more slides of the plurality of slides. In some embodiments, the support comprises a guide and the plurality of slides slide along the guide to transfer the slides between the first container and the second container.

At a step 760, a linkage operatively coupled to a processor and the support moves the slides between the first container and the second container.

At a step 770, the slide transfer device positions the plurality of slides to orient a readable code of each of the plurality of slides in the second container within a range of a reader of the microscope.

Although FIG. 7 shows a method 700 of transferring slides in accordance with some embodiments, one of ordinary skill in the art will recognize many adaptations and variations. For example, the steps can be performed in any order, some of the steps repeated and some of the steps not performed. Some of the steps may comprise sub-steps of other steps. Additional steps can be added, for example in accordance with embodiments disclosed herein. At least some of the steps of method 700 can be performed with a processor as described herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor. The processor may comprise a distributed processor system, e.g. running parallel processors, or a remote processor such as a server, and combinations thereof.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical- storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters such as numerals refer to like elements.

As used herein, the term substantially with respect to one or more of an orientation, a direction, horizontal or vertical refers to within 30 degrees.

The present disclosure includes the following numbered clauses.

Clause 1. An apparatus, comprising: a microscope configured to generate magnified digital images of samples; a first container configured to hold a plurality of slides; a second container configured to receive the plurality of slides from the first container, wherein the second container differs from the first container; a slide loader configured to load the plurality of slides from the second container to the microscope; and a transfer device comprising a support configured to transfer the plurality of slides from the first container to the second container.

Clause 2. The apparatus of clause 1, wherein the first container differs from the second container by one or more of a maximum distance across, a slide capacity, a number of slide receptacles, a distance between slide receptacles, or a size of slide receptacles.

Clause 3. The apparatus of clauses 1 to 2, further comprising a reader configured to read an identification code on the container and optionally wherein the code comprises one or more of a bar code, a QR code or an RFID.

Clause 4. The apparatus of clauses 1 to 3, wherein the container comprises an identification code and optionally wherein the code comprises one or more of a bar code, a QR code or an RFID.

Clause 5. The apparatus of clauses 1 to 4, wherein each of the plurality of slides comprises an identification code and optionally wherein the identification code comprises one or more of a bar code, a QR code or an RFID.

Clause 6. The apparatus of clauses 1 to 5, further comprising a reader configured to read an identification code on each of the plurality of slides.

Clause 7. The apparatus of clauses 1 to 6, further comprising a container transfer device configured to move the second container from a slide transfer location to a slide loader location.

Clause 8. The apparatus of clauses 1 to 7, wherein the slide loader is not configured to work with the first container.

Clause 9. The apparatus of clauses 1 to 8, wherein the first container is not compatible with the slide loader.

Clause 10. The apparatus of clauses 1 to 9, wherein the slide loader is not capable of loading slides from the first container when the first container has been placed at a location corresponding to a location of the second container to load slides into the microscope.

Clause 11. The apparatus of clauses 1 to 10, wherein the slide transfer device is configured to sequentially transfer the plurality of slides from the first container to the second container.

Clause 12. The apparatus of clauses 1 to 11, wherein the slide transfer device is configured to maintain an order of the plurality of slides between the first container and the second container.

Clause 13. The apparatus of clauses 1 to 12, wherein the plurality of microscope slides is arranged in a sequential order at a first plurality of locations on the first container and the slide transfer device is configured to transfer the plurality of slides to the second container and maintain the sequential order at a second plurality of locations on the second container.

Clause 14. The apparatus of clauses 1 to 13, wherein the first plurality of locations on the first container corresponds to one or more empty slots between two or more slides on the first container and the second plurality of locations corresponds to no empty slots between the two or more slides on the second container.

Clause 15. The apparatus of clauses 1 to 14, wherein the slide transfer device is configured to change an order of the slides transferred from the first container to the second container.

Clause 16. The apparatus of clauses 1 to 15, wherein the slide transfer device is configured to change the order to prioritize one or more slides of the plurality of slides.

Clause 17. The apparatus of clauses 1 to 16, wherein the slide transfer device is configured to move the plurality of slides simultaneously from the first container to the second container.

Clause 18. The apparatus of clauses 1 to 17, wherein the slide transfer device is configured to transfer the plurality of slides between the first container and the second container in batches.

Clause 19. The apparatus of clauses 1 to 18, wherein the support comprises a guide configured to allow the plurality of slides to slide between the first container and the second container.

Clause 20. The apparatus of clauses 1 to 19, wherein the slide transfer device is configured to transfer the plurality of slides from the second container to the first container.

Clause 21. The apparatus of clauses 1 to 20, wherein the slide transfer device is configured to transfer the plurality of slides from the second container to a third container.

Clause 22. The apparatus of clauses 1 to 21, wherein the second container is configured to hold the plurality of slides simultaneously.

Clause 23. The apparatus of clauses 1 to 22, further comprising a container transferring device between the slide transfer device and the slide loader and optionally wherein the container transferring device is located between a location of the slide transfer device and a location of the slide loader.

Clause 24. The apparatus of clauses 1 to 23, wherein the first container is configured to receive a plurality of smeared slides from a slide preparation device configured to prepare smeared slides and optionally where the slide preparation device comprises an automated slide stainer.

Clause 25. The apparatus of clauses 1 to 24, wherein the first container comprises a cassette configured to hold the plurality of slides in a plurality of slide receptacles and optionally wherein the plurality of receptacles comprises a plurality of slots.

Clause 26. The apparatus of clauses 1 to 25, wherein the second container comprises a cassette configured to hold the plurality of slides in a plurality of slide receptacles and optionally wherein the second container comprises a plurality of slots.

Clause 27. The apparatus of clauses 1 to 26, wherein the slide transfer device comprises a support to move the plurality of slides between the first container and the second container.

Clause 28. The apparatus of clauses 1 to 27, wherein the support comprises one or more of an extension, a finger, fingers, a fork, a grip, an adhesive element, a vacuum holder, a guide, a surface to support the slide, a sliding surface, a pushing mechanism, a pulling mechanism, a magnetic holder, an end effector, or a rotating stage.

Clause 29. The apparatus of clauses 1 to 28, further comprising: a linkage coupled to the support to move the support; and a processor operatively coupled to the linkage to move the slides between the first container and the second container.

Clause 30. The apparatus of clauses 1 to 29, wherein the linkage is configured to move the support, with a slide supported thereon, between a first receptacle of the first container to a second receptacle of the second container.

Clause 31. The apparatus of clauses 1 to 30, wherein the linkage comprises one or more motors coupled to one or more gears to move the support and optionally two or more motors coupled to two or more gears and further optionally three or more motors coupled to three or more gears.

Clause 32. The apparatus of clauses 1 to 31, wherein the linkage comprises one or more of a robotic arm, a 6 or more degree of freedom robotic arm, a translation stage, a two dimensional translation stage, or a three dimensional translation stage, a rotating stage, a gantry, a delta robot, or a pulley.

Clause 33. The apparatus of clauses 1 to 32, wherein the support comprises a sliding surface to guide the plurality of slides between the first container and the second container and optionally wherein the linkage comprises a gear to rotate the sliding surface.

Clause 34. The apparatus of clauses 1 to 33, wherein the processor is configured with instructions to maintain a sequential order of slides from a first sequential order on the first container to a second sequential order on the second container.

Clause 35. The apparatus of clauses 1 to 34, wherein the processor is configured with instructions to change a sequential order of slides from a first sequential order on the first container to a second sequential order on the second container.

Clause 36. The apparatus of clauses 1 to 35, wherein the first container, the slide transfer device, the slide and the slide loader are arranged in sequence to receive a plurality of slides from a slide preparation device in the first container, transfer the plurality of slides from the first container to the second container, and sequentially transfer the plurality of slides from the slide loader to the microscope.

Clause 37. The apparatus of clauses 1 to 36, wherein the microscope comprises one or more of a computational microscope, a high definition microscope, a digital microscope, a scanning digital microscope, a 3D microscope, a phase imaging microscope, a phase contrast microscope, a dark field microscope, a differential interference contrast microscope, a light-sheet microscope, a confocal microscope, a holographic microscope, or a fluorescence-based microscope.

Clause 38. The apparatus of clauses 1 to 37, wherein the plurality of slides comprises a first orientation in the first container and a second orientation in the second container.

Clause 39. The apparatus of clauses 1 to 38, the first orientation is substantially similar to the second orientation.

Clause 40. The apparatus of clauses 1 to 39, wherein the slide transfer device is configured to maintain an orientation of the plurality of slides between the first container and the second container.

Clause 41. The apparatus of clauses 1 to 40, wherein the slide transfer device is configured to change an orientation of the plurality of slides from a first orientation in the first container to a second orientation in the second container.

Clause 42. The apparatus of clauses 1 to 41, wherein the first orientation comprises a substantially vertical orientation and the second orientation comprises a substantially vertical orientation and wherein the first orientation differs from the second orientation by a rotation of the slide about an axis of rotation extending through the slide.

Clause 43. The apparatus of clauses 1 to 42, wherein the first orientation comprises a substantially horizontal orientation and the second orientation comprises a substantially horizontal orientation and wherein the first orientation differs from the second orientation by a rotation of the slide about an axis of rotation extending through the slide.

Clause 44. The apparatus of clauses 1 to 43, wherein the first orientation comprises a substantially horizontal orientation and the second orientation comprises a substantially vertical orientation.

Clause 45. The apparatus of clauses 1 to 44, wherein the first orientation comprises a substantially vertical orientation and the second orientation comprises a substantially horizontal orientation.

Clause 46. The apparatus of clauses 1 to 45, wherein each of the plurality of slides comprises a readable identification code and wherein the slide transfer device is configured to orient readable code in the second container to be read with a reader and optionally wherein the reader comprises one or more of a bar code reader, a QR code reader, or an RFID reader.

Clause 47. The apparatus of clauses 1 to 46, wherein the slide transfer device is configured to position the plurality of slides to orient the readable code in the second container within a range of a reader.

Clause 48. The apparatus of clauses 1 to 47, wherein the first container comprises a first accessible side for accessing the plurality of slides on the first container and the second container comprises a second accessible side for accessing the plurality of slides on the second container.

Clause 49. The apparatus of clauses 1 to 48, wherein the first accessible side comprises one or more openings to access the plurality of slides on a plurality of receptacles of the first container.

Clause 50. The apparatus of clauses 1 to 49, wherein the second accessible side comprises one or more openings to access the plurality of slides on a plurality of receptacles of the second container.

Clause 51. The apparatus of clauses 1 to 50, wherein the first accessible side and the second accessible side comprise a substantially similar orientation.

Clause 52. The apparatus of clauses 1 to 51, wherein the first accessible side and the second accessible side comprise a substantially different orientation.

Clause 53. The apparatus of clauses 1 to 52, wherein the first accessible side comprises a substantially vertical orientation and the second accessible side comprises a substantially vertical orientation.

Clause 54. The apparatus of clauses 1 to 53, wherein the first accessible side comprises a substantially horizontal orientation and the second accessible side comprises a substantially vertical orientation.

Clause 55. The apparatus of clauses 1 to 54, wherein the second container is loaded manually into the microscope after the transfer.

Clause 56. The apparatus of clauses 1 to 55, wherein the apparatus comprises a plurality of microscopes.

Clause 57. A method of transferring slides, the method comprising: transferring a plurality of slides from a first container to a second container with a support configured to move the plurality of slides from the first container to the second container.

Clause 58. The method of clause 57, wherein the first container differs from the second container by one or more of a maximum distance across, a slide capacity, a number of slide receptacles, a distance between slide receptacles, or a size of slide receptacles.

Clause 59. The method of clauses 57 to 58, wherein the plurality of slides comprises one or more of a first orientation or a first order in the first container and the slide transfer device provides the plurality of slides to the second container with one or more of a second orientation or a second order.

Clause 60. The method of clauses 57 to 59, wherein a reader of the slide transfer device reads an identification code of one or more of the plurality of slides, the first container or the second container.

Clause 61. The method of clauses 57 to 60, wherein the slide transfer device is configured to maintain one or more of an order or an orientation of the plurality of slides between the first container and the second container.

Clause 62. The method of clauses 57 to 61, wherein the slide transfer device is configured to change one or more of an order or an orientation of the plurality of slides between the first container and the second container.

Clause 63. The method of clauses 57 to 62, wherein the support engages one or more slides of the plurality of slides.

Clause 64. The method of clauses 57 to 63, wherein the support comprises a guide and the plurality of slides slide along the guide to transfer the slides between the first container and the second container.

Clause 65. The method of clauses 57 to 64, wherein a linkage operatively coupled to a processor and the support moves the slides between the first container and the second container.

Clause 66. The method of clauses 57 to 65, wherein the first container, the slide transfer device, the slide and the slide loader are arranged in sequence and the plurality of sides from a slide stainer is received in the first container, the plurality of slides transferred from the first container to the second container, and transferred from the second container to the slide loader and to the microscope.

Clause 67. The method of clauses 57 to 66, wherein the plurality of slides comprises a first orientation in the first container and a second orientation in the second container.

Clause 68. The method of clauses 57 to 67, wherein the slide transfer device is configured to position the plurality of slides to orient a readable code of each of the plurality of slides in the second container within a range of a reader of the microscope.

Clause 69. The method of clauses 57 to 68, wherein the support accesses the plurality of slides through a first accessible side on first container and through a second accessible side of the second container.

Clause 70. The method or apparatus of any one of the preceding clauses wherein substantially with respect to one or more of an orientation, a direction, horizontal or vertical refers to within 30 degrees.

Embodiments of the present disclosure have been shown and described as set forth herein and are provided by way of example only. One of ordinary skill in the art will recognize numerous adaptations, changes, variations and substitutions without departing from the scope of the present disclosure. Several alternatives and combinations of the embodiments disclosed herein may be utilized without departing from the scope of the present disclosure and the inventions disclosed herein. Therefore, the scope of the presently disclosed inventions shall be defined solely by the scope of the appended claims and the equivalents thereof.

1. An apparatus, comprising:
a microscope configured to generate magnified digital images of samples;
a first container configured to hold a plurality of slides;
a second container configured to receive the plurality of slides from the first container, wherein the second container differs from the first container;
a slide loader configured to load the plurality of slides from the second container to the microscope; and
a transfer device comprising a support configured to transfer the plurality of slides from the first container to the second container.

2. The apparatus of claim 1, wherein the first container differs from the second container by one or more of a maximum distance across, a slide capacity, a number of slide receptacles, a distance between slide receptacles, or a size of slide receptacles.

3. The apparatus of claim 1, further comprising a reader configured to read an identification code on the container and optionally wherein the code comprises one or more of a bar code, a QR code or an RFID.

4. The apparatus of claim 1, wherein the container comprises an identification code and optionally wherein the code comprises one or more of a bar code, a QR code or an RFID.

5. The apparatus of claim 1, wherein each of the plurality of slides comprises an identification code and optionally wherein the identification code comprises one or more of a bar code, a QR code or an RFID.

6. The apparatus of claim 1, further comprising a reader configured to read an identification code on each of the plurality of slides.

7. The apparatus of claim 1, further comprising a container transfer device configured to move the second container from a slide transfer location to a slide loader location.

8. The apparatus of claim 1, wherein the slide loader is not configured to work with the first container.

9. The apparatus of claim 1, wherein the first container is not compatible with the slide loader.

10. The apparatus of claim 1, wherein the slide loader is not capable of loading slides from the first container when the first container has been placed at a location corresponding to a location of the second container to load slides into the microscope.

11. The apparatus of claim 1, wherein the slide transfer device is configured to sequentially transfer the plurality of slides from the first container to the second container.

12. The apparatus of claim 1, wherein the slide transfer device is configured to maintain an order of the plurality of slides between the first container and the second container.

13. The apparatus of claim 1, wherein the plurality of microscope slides is arranged in a sequential order at a first plurality of locations on the first container and the slide transfer device is configured to transfer the plurality of slides to the second container and maintain the sequential order at a second plurality of locations on the second container.

14. The apparatus of claim 13, wherein the first plurality of locations on the first container corresponds to one or more empty slots between two or more slides on the first container and the second plurality of locations corresponds to no empty slots between the two or more slides on the second container.

15. The apparatus of claim 1, wherein the slide transfer device is configured to change an order of the slides transferred from the first container to the second container.

16. The apparatus of claim 15, wherein the slide transfer device is configured to change the order to prioritize one or more slides of the plurality of slides.

18. The apparatus of claim 1, wherein the slide transfer device is configured to move the plurality of slides simultaneously from the first container to the second container.

18. The apparatus of claim 1, wherein the slide transfer device is configured to transfer the plurality of slides between the first container and the second container in batches.

19. The apparatus of claim 1, wherein the support comprises a guide configured to allow the plurality of slides to slide between the first container and the second container.

20. The apparatus of claim 1, wherein the slide transfer device is configured to transfer the plurality of slides from the second container to the first container.

21.-70. (canceled)
